(19) United States
(12) Patent Application Publication
(10) Pub. No.: US 2026/0222396 A1
(43) Pub. Date: Jul. 30, 2026

(54) CLOUD-BASED MDNS MANAGEMENT FOR IOT DEVICES

(71) Applicant: DISH Network L.L.C., Englewood, CO (US)

(72) Inventors: Joshua D. Wade, Castle Rock, CO (US); Jason Anthony Madruga, Castle Rock, CO (US)

(21) Appl. No.: 19/036,170

(22) Filed: Jan. 24, 2025

(51) Int. Cl. H04L 9/40

(52) U.S. Cl. CPC H04L 63/08

(57) ABSTRACT

A method may include receiving, by a connectivity controller of a computing system, a connection request from a user device. The method may include determining, by the connectivity controller of the computing system, and based at least in part on the connection request, a receiver associated with the connection request and user credentials associated with the user device. The method may include determining, by the connectivity controller of the computing system, a status of the receiver. Based on the status of the receiver, the method may include causing, by the connectivity controller of the computing system, a connection packet to be transmitted to the user device, such that a data connection is established between the user device and the receiver.

### BACKGROUND

Various protocols are utilized to enable device-to device connections, such as video casting. In smaller networks, these protocols may be lightweight—not requiring large amounts of bandwidth. In larger networks, however, these protocols may result overwhelm various network resources, leading to service degradation and/or network failures.

### BRIEF SUMMARY

A method may include receiving, by a connectivity controller of a computing system, a connection request from a user device. The method may include determining, by the connectivity controller of the computing system, and based at least in part on the connection request, a receiver associated with the connection request and user credentials associated with the user device. The method may include determining, by the connectivity controller of the computing system, a status of the receiver. Based on the status of the receiver, the method may include causing, by the connectivity controller of the computing system, a connection packet to be transmitted to the user device, such that a data connection is established between the user device and the receiver.

In some embodiments, the user credentials may be associated with a local area network (LAN) and the user device may be connected to the LAN. The method may also include receiving, by the receiver of the computing system, data from the user device via the connection and providing, by the receiver of the computing system, at least some of the data for display. The receiver may be included in a set top box. The receiver may be included in an Internet-of-Things (IoT) device. The connectivity controller may access data associated with a plurality of receivers. The connectivity controller may include a cloud-based database. The connection packet may be a multicast domain name system packet.

A computing system may include one or more processors and a computer readable memory including instructions that, when executed by the one or more processors, cause the system to perform operations. According to the operations, the system may receive, by a connectivity controller of the computing system, a connection request from a user device. The system may determine, by the connectivity controller of the computing system, and based at least in part on the connection request, a receiver associated with the connection request and user credentials associated with the user device. Determine, by the connectivity controller of the computing system, a status of the receiver. The system may, based on the status of the receiver, cause, by the connectivity controller of the computing system, a connection packet to be transmitted to the user device, such that a data connection is established between the user device and the receiver.

A non-transitory computer-readable medium may include instructions that, when executed by one or more processors, cause the one or more processors to perform operations. The operations may include determining, by the connectivity controller of the computing system, and based at least in part on the connection request, a receiver associated with the connection request and user credentials associated with the user device. The operations may include determining, by the connectivity controller of the computing system, a status of the receiver. Based on the status of the receiver, the operations may include causing, by the connectivity controller of the computing system, a connection packet to be transmitted to the user device, such that a data connection is established between the user device and the receiver.

### BRIEF DESCRIPTION OF THE DRAWINGS

FIG. 1 illustrates a system and a process for managing connectivity between devices, according to certain embodiments.

FIG. 2A illustrates a system with a multicast environment, according to certain embodiments.

FIG. 2B illustrates a system with a connectivity controller, according to certain embodiments.

FIG. 2C illustrates a system connecting a user device and a receiver, according to certain embodiments.

FIG. 3 illustrates a flowchart of a method for managing multicast connections, according to certain embodiments.

FIG. 4 is a schematic diagram illustrating an example of computer system.

### DETAILED DESCRIPTION

Media consumption habits have changed over time as more and more options for consuming media have been presented. Basic over-the-air television gave way to cable television, which in turn has made way for various streaming services. Users now have a wide variety of options for media consumption, where each user may have their own preferences, desires, etc. Furthermore, a user may have media on an associated user device that they wish to access via another device such as a display.

In order to accommodate these user preferences, devices and systems may allow the user device to transmit the media (or “cast”) so that the media can be displayed on some device other than or in addition to the user device. For example, a receiver may be connected to a television. The receiver may not only provide access to one or more media content types (e.g., cable, web-based streams, etc.), but may also allow the user device to cast to the receiver. Similar functionality may be provided by other network devices (e.g., a router, computer, etc.), or built into a display itself.

Commonly, receivers with casting capabilities may operate using multicast domain name system protocols (mDNS) to keep track of various hostnames on a local network connected to the receivers. According to mDNS, a receiver may broadcast (or “multicast”) a message on the local network that identifies the receiver to all other receivers on the local network. This mDNS functionality may generally be enabled at all times that the receiver is turned on. It may be desired to know which devices are active on the local network at any given time. The receiver may also receive a list of all the receivers on the local network. Furthermore, the user device may utilize mDNS to identify and connect with a particular receiver on the local network. For example, the user device may receive the list of all the receivers on the local network and select the particular receiver from the list using a service name provided via mDNS. The user device may then select a receiver and connect to (and cast) to the particular receiver over the local network (or some other network).

In small local networks, mDNS may cause minimal or no issues. The network traffic of a small network may generally be much lower than the total bandwidth available of the network. A small local network may only have a handful of receivers. By contrast, other local networks may include several receivers, each using mDNS. The cumulative effect on network traffic of the receivers using mDNS may cause network slowdowns and/or failures due to heavy traffic. This heavy traffic may further be exacerbated by a plurality of user devices also communicating over the local network. Additionally, although receivers and casting are used in the examples above (and herein), similar issues may arise from any device using mDNS for any purpose. For example, many Internet of Things (IoT) devices may use mDNS for similar local network identification and hostname purposes. Other protocols besides mDNS may also be used and may lead to similar issues. Thus, there is a need to manage mDNS (or other protocols) in a network including a plurality of receivers and/or other devices.

One solution may be to control multicast connection protocol traffic between devices by a connectivity controller. A user device may request a connection with a receiver. For example, the user device may scan an optical code (e.g., a QR code) on the receiver to initiate a connection. The user device may then be directed to the connectivity controller. The user device may transmit a connection request to the connectivity controller via a data link layer according to a multicast protocol (e.g., mDNS). The connectivity controller may then transmit an availability request to the receiver in order to determine whether or not the receiver is available for the connection. In response to determining that the receiver is available, the connectivity controller may then generate and transmit a connection packet according to the multicast protocol (again via the data layer). The connection packet may indicate the receiver, the user device, credentials used by the user device, and/or other information. Using some or all of the connection packet, the user device may then connect to the receiver and transmit data to the receiver wirelessly. The receiver may then render some or all of the data for display.

Because the connection request transmitted by the user device identifies a particular receiver, the connectivity controller may query just the particular receiver to determine whether or not the receiver is available. By contrast, in current solutions, a query is sent to all receivers (either by the user device and/or by the connectivity controller). Responses are then received from each of the receivers, potentially degrading or overwhelming the network. By reducing the number of queries and responses, systems and networks with multiple receivers (or other devices) may function more efficiently.

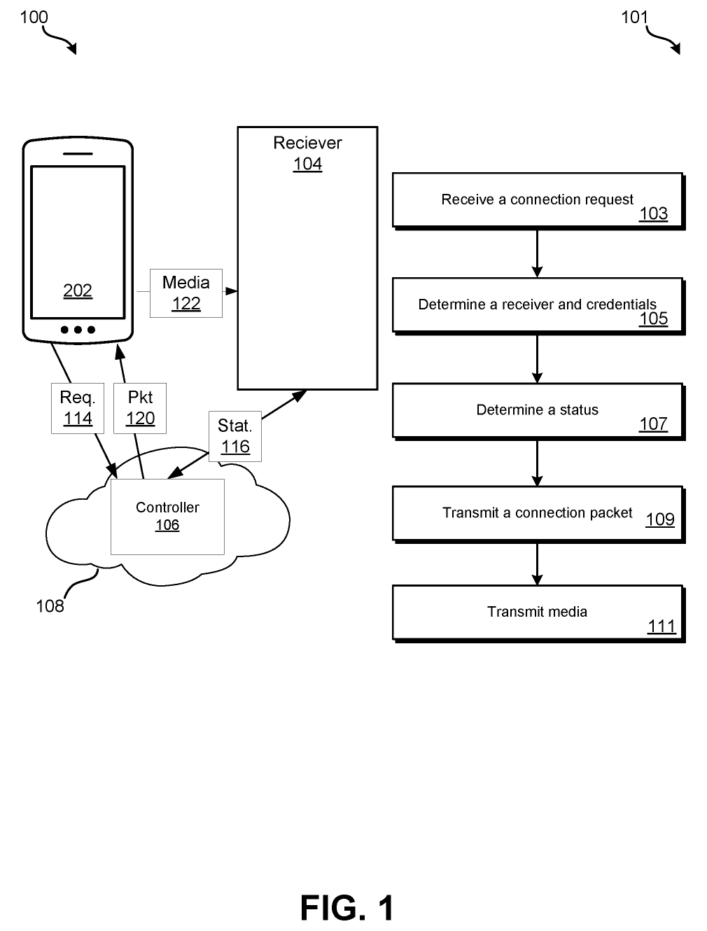

FIG. 1 illustrates a system 100 and a process 101 for managing connectivity between devices, according to certain embodiments. The system 100 may include a user device 102, a receiver 104, and a controller 106. The user device 102 may be a computer mobile phone, smartphone, tablet, laptop, desktop, wearable device, remote control, or any other such device. The user device 102 may be configured to communicate via one or more wireless protocols (e.g., WiFi, Bluetooth, Zigbee, etc.) with other devices and/or networks.

The receiver 104 may be any type of device capable of multicast connection(s) with other devices. The receiver 104 may be a set top box (STB) or other such device configured to receive data and render some or all of the data for display. For example, the receiver 104 may be in a hotel room or other similar environment. The receiver 104 may provide media services within a guest room such a streaming video, live television, etc. The receiver 104 may also be configured to receive a screen share from the user device 102, allowing media accessed by the user device to be cast to the receiver 104 (and displayed on a television or other display). In order to receive data, the receiver 104 may be configured to operate by one or more protocols allowing a private (or semi-private) connection between the user device 102 and the receiver 104 (e.g., mDNS)., Although the examples below may describe the receiver 104 as a set top box or other receiver used for media streaming, it should be understood that the receiver 104 may be any type of Internet of Things (IoT) device. The systems, processes, etc. described below may therefore be applied to any type of IoT device.

The controller 106 may be configured to store and/or manage data and information about the receiver 104 (and other receivers and devices on a network). The controller 106 may be one or more hardware and/or software components, operating to enable multicast connections between devices on one or more networks. The controller 106 may access one or more services (as a component of the controller 106 and/or external datastores) to determine information about the user device 102 and/or the receiver 104. For example, the controller 106 may access a credentialing service (e.g., via an application programming interface (API)) to verify credentials associated with the user device. The controller 106 may additionally or alternatively access the receiver 104 in order to determine a status of the receiver 104. In some embodiments, the controller may be configured to generate a connection packet associated with the receiver and according to a protocol. In other embodiments, the controller 106 may be configured to receive the connection packet from the receiver 104 and transmit the connection packet to the user device 102.

In some embodiments, some or all of the controller 106 may be implemented on a cloud network 108. For example, a database hosted on the cloud network 108 may include information about one or more receivers (or other IoT devices) within a building, region, company, etc. The information may include IP addresses, device ID’s (e.g., a MAC address), device type information, etc. The controller 106 may then modify communications with the receiver 104 and/or the user device 102 based on some or all of the information (e.g., changing a network type, communication type, etc.).

At 103, the user device 102 transmit a connection request 114 to the controller 106. The connection request may include information identifying the user device 102 (e.g., user credentials), the receiver 104, a connection type, and other such information. For example, the user device 102 may be a mobile device associated with a guest in a hotel. The user device 102 may therefore be logged on to a network associated with a hotel (e.g., a guest network LAN) and have credentials associated therewith. When the guest goes to their room, the guest may scan an optical code (e.g., a QR code) on the receiver 104, receive a near-filed communication (NFC) signal, a user input, etc. in order to initiate a data connection (e.g., to stream video to the receiver 104). The user device 102 may then be redirected to the connectivity controller (e.g., via a layer 2 connection) and transmit the connection request 114 via a multicast protocol such as mDNS and/or other suitable protocols.

At 105, the controller 106 may determine the receiver 104 and/or the user credentials associated with the user device 102 based at least in part on the connection request. 114. For example, the connection request 114 may identify the user device 102 via a device identifier and/or user credentials. The connection request 114 may also identify the receiver 104 via a receiver ID, IP address, MAC address, etc. The controller 106 may then verify the user credentials to ensure that the user device 102 should have access to the receiver 104 and/or the controller 104. To do so, the controller 106 may make one or more API calls to verify that the user device 102 is authenticated to the LAN and/or should be granted access to the receiver 104. If the receiver 104 is associated with a different room than the room associated with the user device 102 (for example), the controller 106 may refuse the connection request 114. The user device 102 may then display an error or other notification. If the controller 106 determines that the user device 102 should be permitted to connect to the receiver 104, the process 101 may continue.

At 107, the controller 106 may determine a status of the receiver 104. The controller 106 may send a status request 116 to the receiver 104. If the receiver 104 is available for connection, the receiver 104 may indicate so in response to the status request. For example, the receiver 104 may be on and not connected to another device. Then, the receiver 104 may be available for connection to the user device 102. In some embodiments, the receiver 104 may transmit a connection packet 120 to the controller 106. Additionally or alternatively, the controller 106 may generate the connection packet 120.

At 109, the connection packet 120 may be transmitted to the user device 102. The connection packet 120 may adhere to a multicast protocol such as mDNS (or any other suitable protocol). The multicast protocol of the connection packet 120 may be based at least in part on the connection request 114. For example, the connection request 114 may adhere to the mDNS protocol. The user device 102, therefore, may expect a response also adhering to the mDNS protocol. Thus, the connection packet 120 may be formatted and transmitted using the mDNS protocol. One of ordinary skill in the art would recognize many other possibilities. In some embodiments, the receiver 104 may transmit the connection packet 120 to the user device 102. In other embodiments, the controller 106 may transmit the connection packet 120 to the user device 102.

At 111, a data connection may be made between the user device 102 and the receiver 104 such that media 122 may be transmitted to the receiver 104 by the user device 102. The data connection may be made over the LAN, Bluetooth, or any other suitable network and/or protocol. The receiver 104 may then display some or all of the media 122.

In current systems, the user device 102 may broadcast the connection request 114 when trying to connect to the receiver 104. However, every receiver (or other IoT device) within range of the broadcast may receive the request and respond. In smaller networks, with relatively small numbers of devices, the multicast protocol may function appropriately. However, in larger networks, thousands of devices may respond to the request, overwhelming networks. The system 100 and process 101 may reduce the network traffic as only the receiver 104 responds after being verified by the controller 106.

Although the preceding example was described using the receiver 104 and the user device 102 for streaming media, any IoT device (or other multicast device) may utilize similar processes and systems. For example, the user device 102 may attempt to connect to a lighting system, climate control system, baby monitor, etc. In an environment with a plurality of multicast-enabled devices (IoT device), the systems and process above.

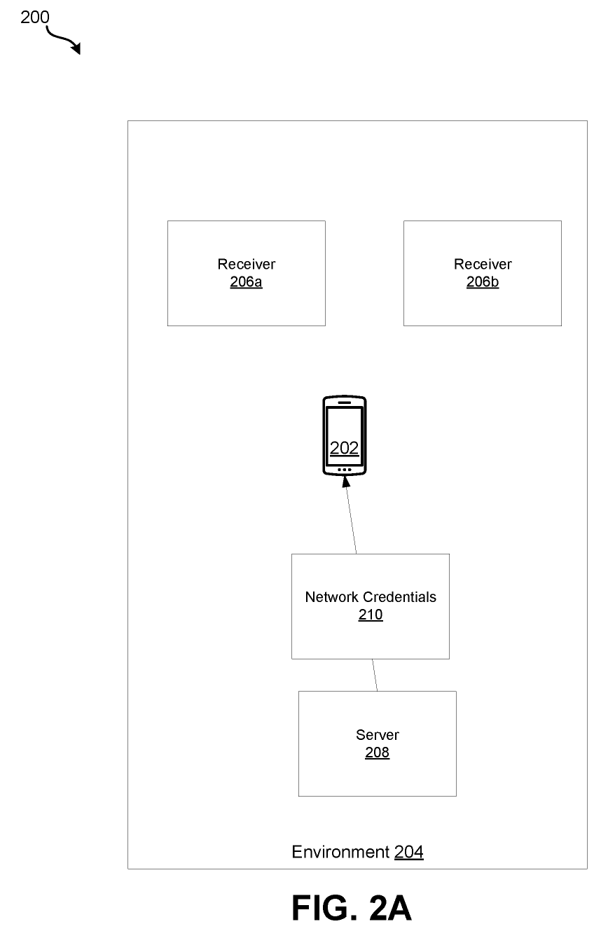

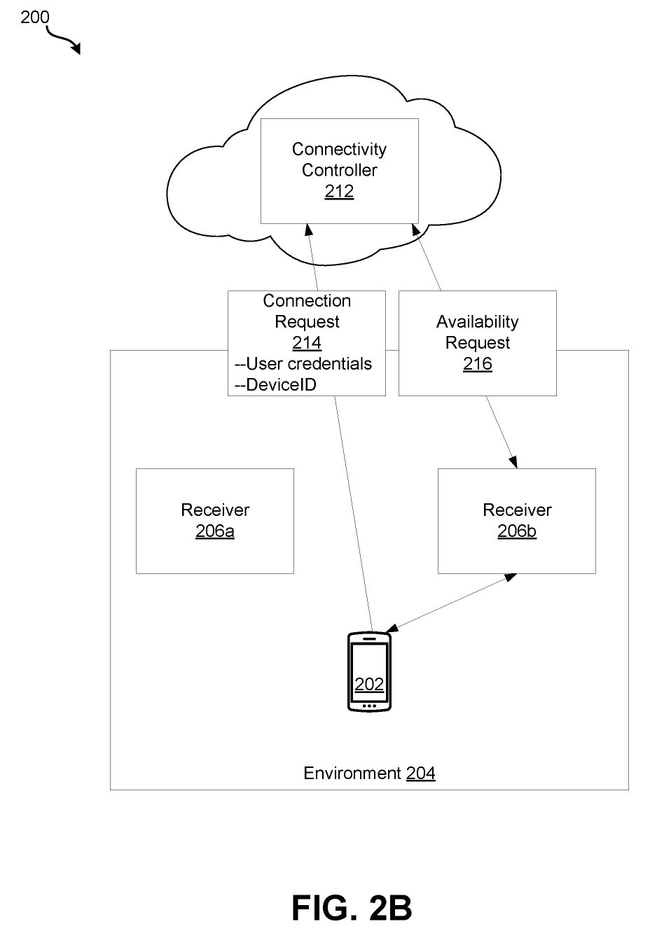

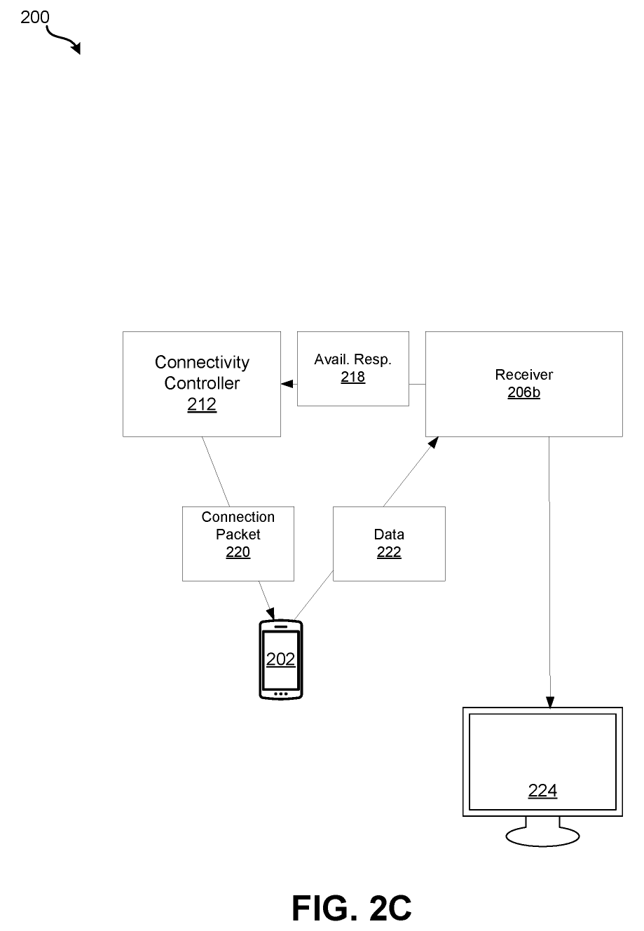

FIG. 2A illustrates a system 200 with a multicast environment 204, according to certain embodiments. The system 200 may include a user device 202, receivers 206a-b, and a server 208. The user device 202 may be a mobile device such as a smartphone, a tablet, a wearable device, a laptop, or any other such device. The user device 202 may be associated with a user and be capable of transmitting and receiving signals over one or more networks and protocols. The environment 204 may be any setting with multiple devices that can operate using multicast protocols.

The receivers 206a-b may be set top boxes (STBs) for displaying media on monitors, televisions, etc. For example, the receivers 206a-b may be just tow of many (hundreds, thousands, etc) of STBs and/or other IoT devices within a hotel. Using standard mDNS protocols (or other protocols) each of the receivers and/or It should be understood, however, that this disclosure is not limited to STBs; any IoT device may use similar systems and techniques as described herein.

The server 208 may be one or more a physical and/or virtual machines configured, at least in part, to authenticate user devices (i.e., the user device 202) to a network within the environment 204. In some embodiments, the server 208 may not be a server at all, but a collection of services etc. running on multiple computers. For example, the server 208 may be part of a back-of-house administration system within a hotel or other large environment. The server 208 may therefore be configured to manage guest registration, check-ins, and provide credentials to guests (users). Thus, as shown in FIG. 2A, the user device 202 may be associated with a guest of a hotel (the environment 204). When the user checks in, the user device 202 may be registered with the server 208 and provided with credentials to access a LAN such as a guest network. The server 208 may also indicate a receiver such as the receiver 106b as being associated with the user device 202.

Put differently, the server 208 may register the user device 202 and associate the user device 202 with IoT devices which may be accessed by the user device 202, such as those in their guest room. As shown in FIG. 2A, the receiver 106b may be associated with the guest room. Thus, the server 208 may determine that the user device 202 should have access to the receiver 106b while not having access to any other receivers. Then the server 208 may issue network credentials 210 to the user device 202. The network credentials 210 may be associated with the user device 202 and/or may be able to be used by multiple devices associated with the user. The user credentials 210 may be based on and/or include information associated with a permitted receiver. For example, a user name of the user credentials 210 may be a guest room associated with the receiver 206b. Thus, when the user device 202 provides the user credentials 210 to some device, the device may be able to determine which devices (i.e., those within the guest room) the user device is permitted to access.

FIG. 2B illustrates the system 200 with a connectivity controller 212, according to certain embodiments. The connectivity controller 212 may be similar to the controller 106 in FIG. 1. The connectivity controller 212 may thus be one or more hardware and/or software components, configured to enable multicast communication protocols in a large environment (e.g., the environment 204). The connectivity controller 212 may be at least partially included within the environment 204. Because many multicast protocols utilize wireless communication via the data link layer (layer 2), a component of the connectivity controller 212 may communicate with various devices (e.g., the user device 202, the receiver 106b, etc.) within the environment 204 in order to enable connectivity between devices.

The user device 202 may attempt to connect with the receiver 106b. For example, the receiver 106b may include an optical code (e.g., a bar code, a QR code, etc.) that may be input to the user device 202 via a scanner, camera, or other such appropriate component. The user device 202 may then determine (based on the information encoded by the optical code), a device ID associated with the receiver 106b, a device type, and/or other such information. Other input methods may additionally or alternatively be used. Other input methods may include an NFC communication, a user input, one or more wireless signals (e.g., Bluetooth, WiFi, etc.), and other suitable means.

The input (e.g., the optical code) may redirect the user device 202 to connect first with the connectivity controller 212. In traditional multicast protocols, the user device 202 may broadcast a connection request 214 in order to connect with the receiver 206b. The receiver 206a, the receiver 206b, and any other multicast enabled devices may then receive the connection request and respond in kind. As shown here, however, the receivers206a-b may not have a multicast connection protocol active. Instead, the connectivity controller 212 may receive the connection request 214. The user device 202 may route the connection request 214 directly to the connectivity controller 212 and/or the user device 202 may broadcast the connection request 214. The connection request 214 may include the user credentials (i.e., the network credentials 208), the device ID identifying the receiver 206b, a device type (e.g., an STB, clock/radio, etc.), a connection type (e.g., casting, audio playback, control, etc.), and/or any other such information.

The connectivity controller 212 may access a datastore including some or all of the information included in the connection request 214. The datastore may be included in the connectivity controller (e.g., on the same physical machine), on an outside computer (e.g., the server 208), on a cloud-based datastore, or any combination thereof. Upon receiving the connection request 214, the connectivity controller 212 may verify the user credentials included in the connection request 214. To do so, the connectivity controller 212 may access the datastore, make one or more API calls (e.g., to a service connected to the server 208), or perform other tasks to verify the user credentials.

The connectivity controller 212 may also determine which (if any) devices the user device 202 is permitted to access. Continuing the example from above, the environment 204 may be a hotel or other such large environment. The user device 202 may be a guest’s device, and therefore be permitted to access some set of the devices within the environment 204 (e.g., devices within the guest’s room such as the receiver 206b, climate controls, etc.). Because the user credentials in the connection request 214 may identify the guest’s room, the connectivity controller 212 may identify the permitted devices based on the user credentials. The connectivity controller 212 may access a list of devices associated with the guest’s room (i.e., on the data store) and automatically that the user device 202 is permitted to access those devices.

The connectivity controller 212 may identify the receiver 206b based at least in part on the information included in the connection request. The connectivity controller 212 may determine that the user device 202 wants to connect to the receiver 206b based on the device ID included in the connection request, the datastore, or some combination thereof. The connectivity controller 212 may then transmit an availability request 216 to the receiver 206b. The availability request 216 may include a query to determine whether the receiver 206b is able to be connected to by the user device 202. For example, the receiver 206b may be connected to another device, powered off, be malfunctioning etc. Thus, the availability request 216 may cause the receiver 206b to perform a one or more checks of various components and/or operational statuses (e.g., power, connection status, etc.) in order to respond to the availability request 216.

FIG. 2C illustrates the system 200 connecting the user device 202 and the receiver 206b, according to certain embodiments. The receiver 106b may be available for connection. In response to the availability request 216 in FIG. 2B, the receiver 106b may transmit an availability response 218 to the connectivity controller 212. The availability response 218 may indicate one or more statuses of the receiver 206b. For example, the availability response 218 may indicate that the receiver 206b is powered on and a connection available for the user device 202 to utilize.

The connectivity controller 212 may then transmit a connection packet 220 to the user device 202. The connection packet 220 may be generated in accordance with a multicast protocol used in the connection request 214. If, for example, the connection request 214 was generated using mDNS, the connection packet 220 may also be generated using mDNS. In some embodiments, the connection packet 220 may be generated by the receiver 206b. As described above, the receiver 206b may have multicast protocol functionalities disabled. In response to the availability request 216, the receiver 206b may enable the multicast protocol functionalities, generate the connection packet 220, and transmit the connection packet 220 with the availability response 218. The receiver 206b may then disable the multicast protocol functionalities again. In other embodiments, the connectivity controller 212 may generate the connection packet 220. Using some or all of the information in the datastore, the availability response 218, and/or the connection request 214, the connectivity controller 212 may generate the connection packet 220 to appear to be from the receiver 206b. Other configurations and possibilities may also be considered.

The user device 202 and the receiver 206b may then utilize the connection packet 220 to establish a data connection. In the example shown in FIG. 2C, the data connection may be a streaming or casting connection, such that data from the user device 202 may be received by the receiver 206b and rendered for display. The user device 202 may transmit data 222 to the receiver 206b using the data connection. The data 222 may be audio, video, a mirroring application, etc. The receiver 206b may then render some or all of the data 222 and output the rendered data on a display 224. In other embodiments, the data connection may be used to control the receiver 206b. For example, the data connection may be used to control the receiver 206b (similar to a remote control) in media display operations, climate control operations, lighting, etc. One of ordinary skill in the art would recognize many different possibilities.

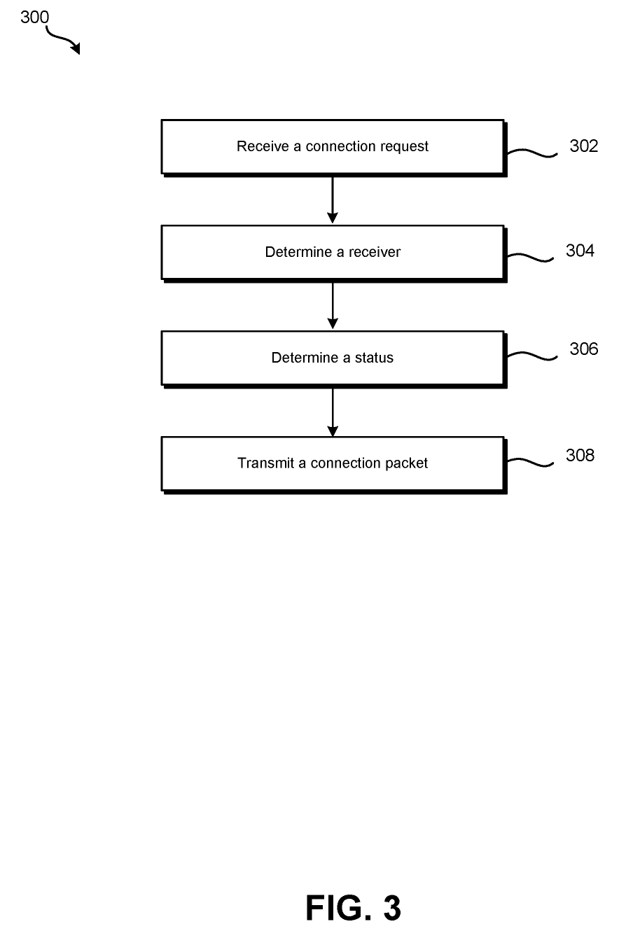

FIG. 3 illustrates a flowchart of a method 300 for managing multicast connections, according to certain embodiments. The method 300 may be performed by some or all of the systems described herein, such as the system 200 in FIG. 2. Some of the steps of the method 300 may be performed in a different order than is shown in FIG. 3, and/or some steps may be combined with other steps. In some embodiments, some steps may be skipped altogether.

At step 302, the method 300 may include receiving, by a connectivity controller of a computing system, a connection request from a user device. The computing system may include one or more physical and/or virtual computers working in conjunction with one another. The computing system may also include one or more services, datastores, and other logical components and/or software components. The connectivity controller may access one or more components of the computing system in order to provide multicast connections between devices. The connectivity controller may include a device implemented in an environment (e.g., the environment 204 in FIG. 2A) with multiple multicast devices. Thus, the connectivity controller may be implemented with a component able to communicate with one or more devices within the environment (e.g., layer 2 communications). The connectivity controller may be configured to communicate using various multicast protocols, such as mDNS and/or other such protocols.

The connection request may be received from a user device (e.g., the connection request 214). For example, the user device may attempt to connect to a receiver. The receiver may include an optical code (e.g., a bar code, a QR code, etc.) that may be input to the user device via a scanner, camera, or other such appropriate component. The user device may then determine (based on the information encoded by the optical code), a device ID associated with the receiver, a device type, and/or other such information. Other input methods may additionally or alternatively be used. Other input methods may include an NFC communication, a user input, one or more wireless signals (e.g., Bluetooth, WiFi, etc.), biometric based scanning (e.g., fingerprint, facial scanners, etc.) and/or other suitable means.

At 304, the method 300 may include determining, by the connectivity controller of the computing system, a receiver associated with the connection request and user credentials associated with the user device. The connectivity controller may determine the receiver based at least in part on the connection request. The connection request may include a device ID associated with the receiver. Additionally or alternatively, the connectivity controller may access a datastore. Using some or all of the information included in the connection request (e.g., user credentials), the connectivity controller may determine a list of one or more devices that the user device is permitted to access, including the receiver. For example, if the environment is a hotel, the user device may be associated with a specific room. The user device may be permitted to access an STB within the room, and other IoT devices, but not those devices in other rooms. The connectivity controller may then access the list of devices associated with the specific room and determine that the user device is permitted to access those devices based on the user credentials.

At step 306, the method 300 may include determining, by the connectivity controller of the computing system, a status of the receiver. The connectivity controller may transmit an availability request to the receiver. The availability request may include a query to determine whether the receiver is able to be connected to by the user device. For example, the receiver may be connected to another device, powered off, be malfunctioning etc. Thus, the availability request may cause the receiver to perform a one or more checks of various components and/or operational statuses (e.g., power, connection status, etc.) in order to respond to the availability request.

At step 308, the method 300 may include causing, by the connectivity controller of the computing system, a connection packet to be transmitted to the user device, such that a data connection is established between the user device and the receiver. The connectivity controller may then transmit a connection packet to the user device. The connection packet may be generated in accordance with a multicast protocol used in the connection request. If, for example, the connection request was generated using mDNS, the connection packet may also be generated using mDNS. In some embodiments, the connection packet may be generated by the receiver. As described above, the receiver may have multicast protocol functionalities disabled. In response to the availability request, the receiver may enable the multicast protocol functionalities, generate the connection packet, and transmit the connection packet with the availability response. The receiver may then disable the multicast protocol functionalities again. In other embodiments, the connectivity controller may generate the connection packet. Using some or all of the information in the datastore, the availability response, and/or the connection request, the connectivity controller may generate the connection packet to appear to be from the receiver. In some embodiments, the receiver may receive data from the user device via the data connection. The receiver may then render some or all of the data for display and provide the rendered data to a monitor or other such device.

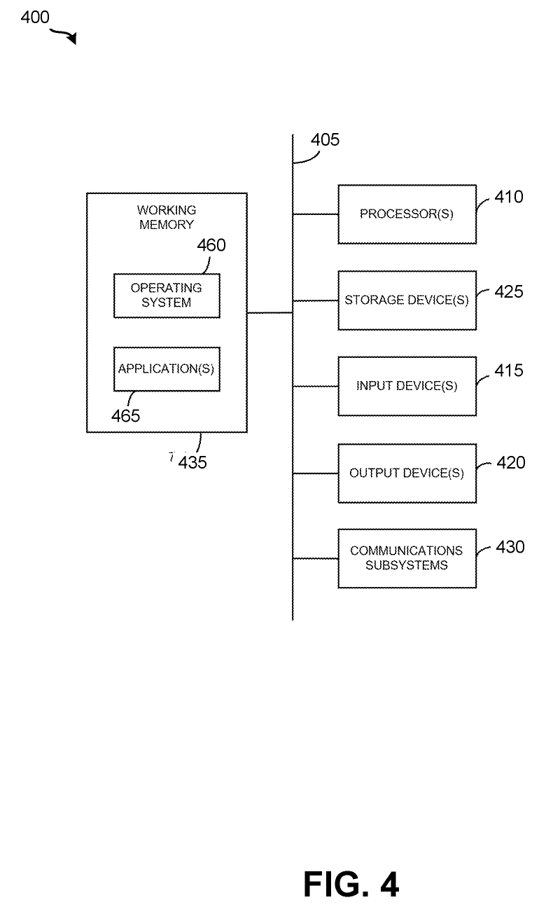

FIG. 4 is a schematic diagram illustrating an example of computer system 400. The computer system 400 is a simplified computer system that can be used to implement various embodiments described and illustrated herein. A computer system 400 as illustrated in FIG. 4 may be incorporated into devices such as a portable electronic device, mobile phone, or other device as described herein. FIG. 4 provides a schematic illustration of one embodiment of a computer system 400 that can perform some or all of the steps of the methods and workflows provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown including hardware elements that can be electrically coupled via a bus 405, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 415, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 425, which can include, without limitation, local and/or network accessible storage, and/or can include, without limitation, a disk drive, a drive array, an optical storage device, a solid-state storage device, such as a random access memory ("RAM"), and/or a read-only memory ("ROM"), which can be programmable, flash-updateable, and/or the like. Such storage devices may be configured to implement any appropriate data stores, including without limitation, various file systems, database structures, and/or the like.

The computer system 400 might also include a communications subsystem 440, which can include without limitation a modem, a network card (wireless or wired), an infrared communication device, a wireless communication device, and/or a chipset such as a Bluetooth™ device, a 802.11 device, a Wi-Fi device, a Wi-Max device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g., the first electronic device, may be incorporated into the computer system 400, e.g., an electronic device as an input device 415. In some embodiments, the computer system 400 will further include a working memory 435, which can include a RAM or ROM device, as described above.

The computer system 400 also can include software elements, shown as being currently located within the working memory 435, including an operating system 440, device drivers, executable libraries, and/or other code, such as one or more application programs 445, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 425 described above. In some cases, the storage medium might be incorporated within a computer system, such as computer system 400. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 400 to perform methods in accordance with various embodiments of the technology. According to a set of embodiments, some or all of the operations of such methods are performed by the computer system 400 in response to processor 410 executing one or more sequences of one or more instructions, which might be incorporated into the operating system 440 and/or other code, such as an application program 445, contained in the working memory 435. Such instructions may be read into the working memory 435 from another computer-readable medium, such as one or more of the storage device(s) 425. Merely by way of example, execution of the sequences of instructions contained in the working memory 435 might cause the processor(s) 410 to perform one or more procedures of the methods described herein. Additionally, or alternatively, portions of the methods described herein may be executed through specialized hardware.

The terms "machine-readable medium" and "computer-readable medium," as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 425. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 405 then might carry the signals and/or the data, instructions, etc. carried by the signals to the working memory 435, from which the processor(s) 410 retrieves and executes the instructions. The instructions received by the working memory 435 may optionally be stored on a non-transitory storage device 425 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms "a", "an", and "the" include plural references unless the context clearly dictates otherwise. Thus, for example, reference to "a user" includes a plurality of such users, and reference to "the processor" includes reference to one or more processors and equivalents thereof known in the art, and so forth.

Also, the words "comprise", "comprising", "contains", "containing", "include", "including", and "includes", when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A method, comprising:
receiving, by a connectivity controller of a computing system, a connection request from a user device; and
determining, by the connectivity controller of the computing system, and based at least in part on the connection request, a receiver associated with the connection request and user credentials associated with the user device;
determining, by the connectivity controller of the computing system, a status of the receiver;
based on the status of the receiver:
causing, by the connectivity controller of the computing system, a connection packet to be transmitted to the user device, such that a data connection is established between the user device and the receiver.

2. The method of claim 1, wherein the user credentials are associated with a local area network (LAN) and the user device is connected to the LAN.

3. The method of claim 1, further comprising:
receiving, by the receiver of the computing system, data from the user device via the connection; and
providing, by the receiver of the computing system, at least some of the data for display.

4. The method of claim 1, wherein the receiver is comprised in a set top box.

5. The method of claim 1, wherein the receiver is comprised in an Internet-of-Things (IoT) device.

6. The method of claim 1, wherein the connectivity controller accesses data associated with a plurality of receivers.

7. The method of claim 1, wherein the connectivity controller comprises a cloud-based database.

8. The method of claim 1, wherein the connection packet is a multicast domain name system packet.

9. A computing system, comprising:
one or more processors; and
a computer readable memory comprising instructions that, when executed by the one or more processors, cause the system to perform operations to:
receive, by a connectivity controller of the computing system, a connection request from a user device;
determine, by the connectivity controller of the computing system, and based at least in part on the connection request, a receiver associated with the connection request and user credentials associated with the user device;
determine, by the connectivity controller of the computing system, a status of the receiver; and
based on the status of the receiver:
cause, by the connectivity controller of the computing system, a connection packet to be transmitted to the user device, such that a data connection is established between the user device and the receiver.

10. The system of claim 9, wherein the user credentials are associated with a local area network (LAN) and the user device is connected to the LAN.

11. The system of claim 9, further comprising:
receiving, by the receiver of the computing system, data from the user device via the connection; and
providing, by the receiver of the computing system, at least some of the data for display.

12. The system of claim 9, wherein the receiver is comprised in a set top box.

13. The system of claim 9, wherein the receiver is comprised in an Internet-of-Things (IoT) device.

14. The method of claim 1, wherein the connectivity controller accesses data associated with a plurality of receivers.

15. The method of claim 1, wherein the connectivity controller comprises a cloud-based database.

16. The method of claim 1, wherein the connection packet is a multicast domain name system packet.

17. A non-transitory computer-readable medium comprising instructions that, when executed by one or more processors, cause the one or more processors to perform operations comprising:
receiving, by a connectivity controller of a computing system, a connection request from a user device; and
determining, by the connectivity controller of the computing system, and based at least in part on the connection request, a receiver associated with the connection request and user credentials associated with the user device;
determining, by the connectivity controller of the computing system, a status of the receiver;
based on the status of the receiver:
causing, by the connectivity controller of the computing system, a connection packet to be transmitted to the user device, such that a data connection is established between the user device and the receiver.

18. The non-transitory computer-readable medium of claim 17, wherein the user credentials are associated with a local area network (LAN) and the user device is connected to the LAN.

19. The non-transitory computer-readable medium of claim 17, further comprising:
receiving, by the receiver of the computing system, data from the user device via the connection; and
providing, by the receiver of the computing system, at least some of the data for display.

20. The non-transitory computer-readable medium of claim 17, wherein the receiver is comprised in a set top box.
